(19) United States
(12) Patent Application Publication
(10) Pub. No.: US 2009/0185503 A1
(43) Pub. Date: Jul. 23, 2009

(54) NETWORK TRAFFIC ANALYZING DEVICE, NETWORK TRAFFIC ANALYZING METHOD AND NETWORK TRAFFIC ANALYZING SYSTEM

(75) Inventor: Joohwa TAN, Saitama (JP)

Correspondence Address: POSZ LAW GROUP, PLC, 12040 SOUTH LAKES DRIVE, SUITE 101, RESTON, VA, 20191, US

(73) Assignee: OKI ELECTRIC INDUSTRY CO., LTD., Tokyo (JP)

(21) Appl. No.: 12/355,060

(22) Filed: Jan. 16, 2009

(30) Foreign Application Priority Data
Jan. 18, 2008 (JP) 2008-009470

(51) Int. Cl. H04L 12/26

(52) U.S. Cl. 370/252

(57) ABSTRACT

A network traffic analyzing device accurately analyzes traffic of a communications network. The traffic analysis device includes a real time statistic information setting/managing unit for collecting information regarding communication data between a primary network and an access network from a traffic collecting device in real time. The device also includes a real time statistic information monitoring unit, an alert condition setting unit for alerting one or more conditions regarding the information collected from the traffic collecting device in real time, and an alert managing/notifying unit for generating an alert regarding traffic between the network and the access network based upon one or more alert conditions.

### CROSS REFERENCE TO RELATED APPLICATION

The present application is related to, claims priority from and incorporates by reference Japanese Patent Application No. 2008-009470, filed on Jan. 18, 2008. This application is also related to co-pending application Ser. No. ______ (attorney docket no. 98A-002) filed concurrently herewith and entitled NETWORK TRAFFIC ANALYZING DEVICE, NETWORK TRAFFIC ANALYZING METHOD AND NETWORK TRAFFIC ANALYZING SYSTEM.

### TECHNICAL FIELD

The present invention relates to a traffic analyzing device, a traffic analyzing method and a traffic analyzing system.

### BACKGROUND

Conventionally, as a method of analyzing network traffic, requesting venders to analyze network traffic based on data collected by a traffic collecting device is a known technique. Further, another known technique requires converting the network traffic data collected by the traffic collecting device as is into a counter table or graph and having an administrator (or manager) conduct an analysis based upon the converted data.

However, recently, types and amounts of traffic transmitted over an Internet Protocol (IP) network have increased due to the integration of audio, video and data. So understanding and management of network traffic conditions has become essential from the standpoint of network (NW) operation and provision of certain quality services. Consequently, for the purpose of enabling the collection of the network traffic, a traffic collecting device has been developed.

For the purpose of more precisely understanding the condition of a network, the accuracy of data to be collected is improved and types of traffic to be collected are also increased. In association with this, the collected data becomes massive and the data analysis becomes more and more complicated. When there is no know-how of network traffic analysis, a problem where particular emphasis on the analysis is not certain and the analysis becomes difficult occurs. Further, another problem where it takes time to draw, process and analyze massive amounts of data also occurs. In association with this, the burden placed on an administrator and network operation costs are increased.

### SUMMARY

In view of the above-mentioned problems, a novel and improved traffic analyzing device, traffic analyzing method and traffic analyzing system enable certain and highly accurate analyses of network traffic (or traffic) to be performed.

According to one exemplary embodiment, a traffic analysis device for analyzing traffic of an access network to be connected to a network includes a real time monitoring unit configured to collect information regarding communication data between a network and an access network from a traffic collecting device in real time, an alert condition setting unit configured to set an alert for one or more conditions regarding the information collected from the traffic collecting device in real time, and an alert managing/notifying unit configured to generate an alert regarding traffic between the network and the access network based upon one or more alert conditions is provided.

According to the above-mentioned configuration, in a traffic analyzing device for analyzing traffic of an access network to be connected to a network, information regarding communication data between the network and the access network is collected from a traffic collecting device in real time, alert conditions regarding the information collected from the traffic collecting device in real time are set, and an alert regarding the traffic between the network and the access network is generated based upon the set alert conditions. Therefore, abnormal traffic/normal traffic can be monitored and overseen in real time, and in the case of corresponding to the alert condition, the actual condition of the traffic can be easily analyzed by notifying a manager.

Further, the traffic analyzing device may include a traffic analyzing unit for analyzing traffic based upon a graphical representation of per hour, per day or per month regarding the information collected from the traffic collecting device in real time. According to such a configuration, since the traffic can be analyzed based upon such a graphical representation per hour, per day or per month, the actual condition of the traffic can be accurately analyzed.

Further, the traffic analyzing device may include an analysis report creating unit configured to create a report based upon analysis results of the traffic analyzing unit.

According to such configuration, a manager can easily understand the actual condition of the traffic based upon the analysis report.

Further, the information collected from the traffic collecting device in real time includes information collected by a packet filter of the traffic collecting device or information collected as abnormal traffic, and the traffic analyzing unit may conduct a basic statistical analysis of all received packets based upon the information collected by the packet filter, a statistical analysis of the packets within a specific range based upon the information collected by the packet filter or an analysis of the abnormal traffic. According to such configuration, the actual condition of the traffic can be analyzed in detail based upon each analysis condition by a basic statistical analysis of all received packets based upon the information collected by the packet filter, a statistical analysis of the packets within a specific range based upon the information collected by the packet filter or an analysis of the abnormal traffic.

Further, in order to solve the above-mentioned problems, according to another exemplary embodiment, a traffic analysis method includes collecting information regarding communication data between a network and an access network from a traffic collecting device in real time, setting one or more alert conditions regarding the information collected from the traffic collecting device in real time, and generating an alert regarding traffic between the network and the access network based upon the one or more alert conditions.

According to the configuration, information regarding communication data between a network and an access network is collected from a traffic collecting device in real time, alert conditions regarding the information collected from the traffic collecting device in real time are set and an alert regarding the traffic between the network and the access network is generated based upon the set alert conditions. Therefore, abnormal traffic/normal traffic can be monitored and overseen in real time, and in the case of corresponding to the alert conditions, the actual condition of the traffic can be easily analyzed by a manager.

Further, in order to solve the above-mentioned problems, according to another exemplary embodiment, a traffic analyzing system connecting a traffic collecting device for collecting traffic information from a network and an access network with a traffic analyzing unit for analyzing the traffic information including a real time monitoring unit configured to collect information regarding communication data between a network and an access network from the traffic collecting device in real time, an alert condition setting unit configured to set alert conditions relating the information collected from the traffic collecting device in real time and an alert managing/notifying unit configured to generate an alert regarding traffic between the network and the access network is provided.

According to the configuration, in the traffic analyzing system connecting the traffic collecting device for collecting traffic information from a network and an access network with the traffic analyzing device for analyzing the traffic information, wherein in the traffic analyzing device, information regarding communication data between a network and an access network is collected from the traffic collecting device in real time, alert conditions regarding the information collected from the traffic collecting device in real time and an alert regarding traffic between the network and the access network is generated based upon the set alert conditions. Therefore, abnormal traffic/normal traffic are monitored and overseen in real time, and in the case of corresponding to the alert conditions, the actual condition of the traffic can be easily analyzed by a manager.

According to the above exemplary embodiments, a traffic analyzing device (or network traffic analyzing device), a traffic analyzing method (or network traffic analyzing method) and a traffic analyzing system (or network traffic analyzing system) that enable a certain and highly-precise analysis of network traffic can be provided.

### BRIEF DESCRIPTION OF THE DRAWINGS

FIG. 1 is a schematic diagram illustrating a traffic collecting device according to a first exemplary embodiment in a communications network.

FIG. 2A is a schematic diagram illustrating functionality of the traffic collecting device; and FIG. 2B is a schematic diagram illustrating a configuration of the traffic collecting device.

FIG. 3 is a schematic diagram illustrating configurations of an ingress packet filter and egress packet filter.

FIG. 4 is a schematic diagram illustrating a configuration of an abnormal traffic detecting unit.

FIG. 5A and FIG. 5B are a flow diagram illustrating processing by a session processing unit.

FIG. 6A is a schematic diagram illustrating functionality of the traffic analysis device; and FIG. 6B is a schematic diagram illustrating a configuration to realize the functions.

FIG. 7 is a schematic diagram illustrating a functional configuration of an integrated managing device.

FIG. 8 is a schematic diagram illustrating a configuration of a real time statistic information setting/managing unit (part I).

FIG. 9 is a schematic diagram illustrating a configuration of the real time statistic information setting/managing unit (part II).

FIG. 10 is a schematic diagram illustrating processing executed by the real time statistic information monitoring unit.

FIG. 11 is a schematic diagram illustrating a setting to be conducted by an alert condition setting unit.

FIG. 12 is a flow diagram illustrating the processing of an alert managing/notifying unit.

FIG. 13 is a schematic diagram illustrating the processing by a regular report setting/managing unit, a regular statistical information monitoring unit and a regular statistical information report creating unit.

FIG. 14 is a schematic diagram illustrating the processing by a traffic analysis setting/managing unit.

FIG. 15 is a schematic diagram illustrating further processing by the traffic analyzing unit and the analysis report creating unit.

FIG. 16 is a schematic diagram illustrating further processing by the traffic analyzing unit and the analysis report creating unit.

FIG. 17 is a schematic diagram illustrating further processing by the traffic analyzing unit and the analysis report creating unit.

FIG. 18 is a schematic diagram illustrating further processing by the traffic analyzing unit and the analysis report creating unit.

### DETAILED DESCRIPTION

Hereafter, exemplary embodiments are described in detail with reference to attached drawings. Furthermore, in the present specification and drawings, components having substantially the same function and configuration are marked with the same symbols, respectively, so that redundant descriptions are omitted.

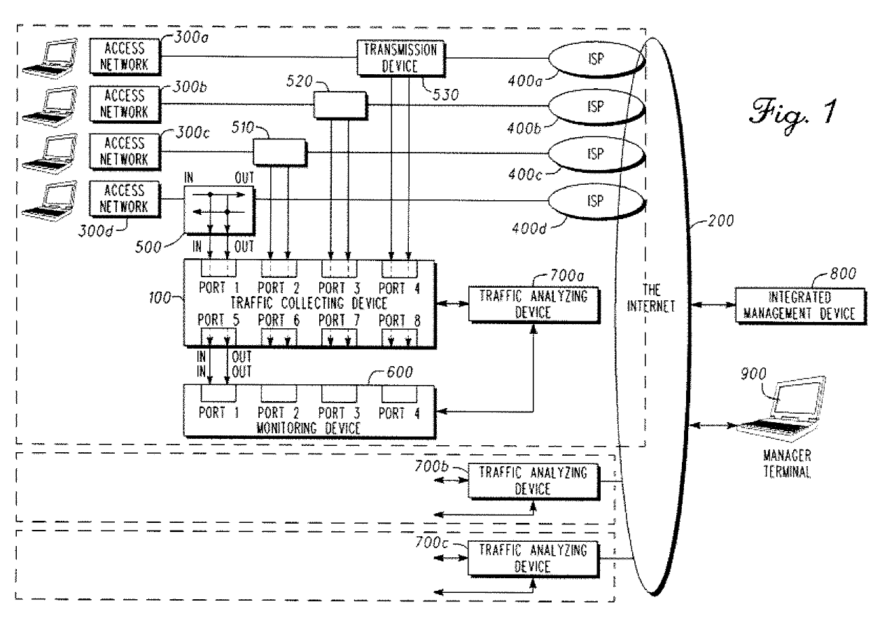

Referring to FIG. 1, a first exemplary embodiment will be described. Specifically, a traffic collecting device 100, which is installed in order to connect to a communications network (primary network) 200, which is depicted in FIG. 1 as the Internet, is shown. Transmission devices (network tap devices) 500, 510, 520, and 530 dividing and outputting communication signals are respectively disposed at lines between access networks 300a, 300b, 300c, 300d and Internet Services Providers (ISPs) 400a, 400b, 400c, 400d. The divided output lines of input (In) side (the side on which access networks 300a-300d are located) and output (Out) side (the side on which ISPs 400a-400d are located) of each of the transmission devices 500, 510, 520, and 530 are respectively connected to the In sides and Out sides on the line side of the traffic collecting device 100. Similarly, the output lines of the traffic collecting device 100 at its monitor side are connected to a monitoring device 600. In the example shown in FIG. 1, it is assumed that the monitoring device 600 is a device that can be installed independently in an in-line manner.

As shown in FIG. 1, a network traffic analyzing device 700a for analyzing traffic is connected to the traffic collecting device 100 and the monitoring device 600.

Traffic information, which is alternatively referred to as traffic data, on the lines between the access networks 300a-300d and the ISPs 400a-400d is respectively collected by the transmission devices 500-530 and the traffic collecting device 100. The network traffic analyzing device 700a automatically analyzes the traffic information collected from the lines, extracts data related to the importance of the analysis results, and creates an analysis report. The network traffic analyzing device 700a regularly collects the traffic information at a preset interval, monitors the traffic, displays a table and a graph of the collected information in real time, and creates a regular report or an analysis report.

Further, a network traffic analyzing device 700b and a network traffic analyzing device 700c analyze information collected by respective traffic collecting devices through respective transmission devices disposed at lines between other access networks 300 and ISPs in a similar manner. However, for simplicity of explanation, only a detailed description of the structure and operation of the network traffic analyzing device 700a is provided.

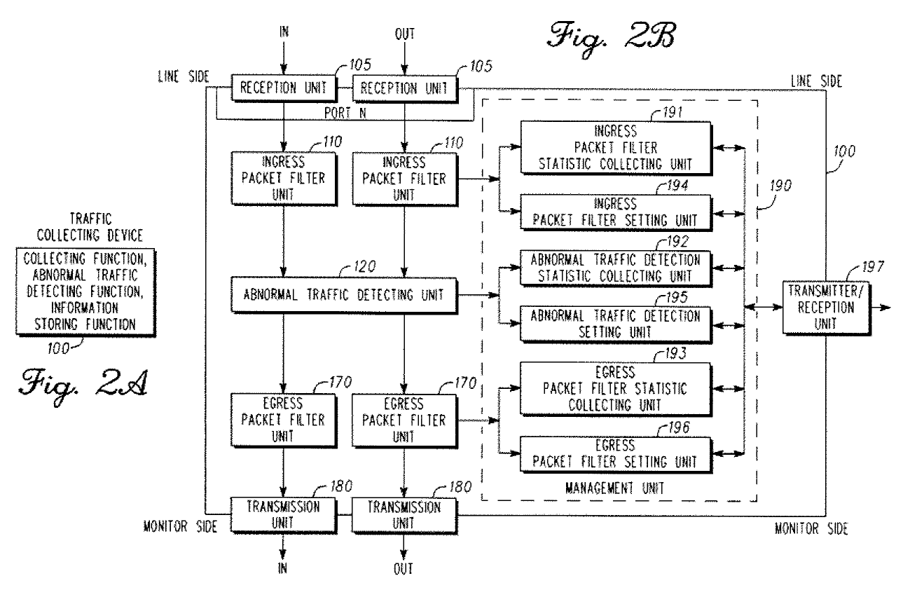

As shown in FIG. 2A, the traffic collecting device 100 has a collection function, an abnormal traffic detecting function, and an information storing function. FIG. 2B is a functional schematic diagram of the traffic collecting device 100. The traffic collecting device 100 includes a reception unit 105, an input (Ingress) packet filter unit 110, an abnormal traffic detecting unit 120, an output (Egress) packet filter unit 170, a transmission unit 180 and a management unit 190. The reception unit 105 separately receives inputs of In sides and Out sides from the transmission devices 500, 510, 520, and 530. The input (Ingress) packet filter unit 110 extracts and searches identifiers of an ether header, an IP header, and a TCP/UDP header of packets from each of the transmission devices 500, 510, 520, and 530 of the line side, and the Ingress packet filter unit 110 performs filtering based on the identifiers.

The abnormal traffic detecting unit 120 processes packets from both the In sides and the Out sides passing through the Ingress packet filter unit 110, thereby recognizing the packets as sessions.

The output (Egress) packet filter unit 170 can perform filtering on packets based on the identifier of the header as well as the performance of the Ingress packet filter unit 110. The packets passing through Egress packet filter unit 170 are transmitted from a transmission unit 180 at the monitor side.

The management unit 190 includes a statistic collecting unit 191 of the Ingress packet filter unit 110, a statistic collecting unit 192 of the abnormal traffic detecting unit 120, a statistic collecting unit 193 of the Egress packet filter unit 170, a setting unit 194 of the Ingress packet filter unit 110, a setting unit 195 of the abnormal traffic detecting unit 120, and a setting unit 196 of the Egress packet filter unit 170.

The management unit 190 is connected to the network traffic analyzing unit 700a through a transmission/reception unit 197, and serves as an interface of statistic information and setting information for communicating with the network traffic analyzing device 700a.

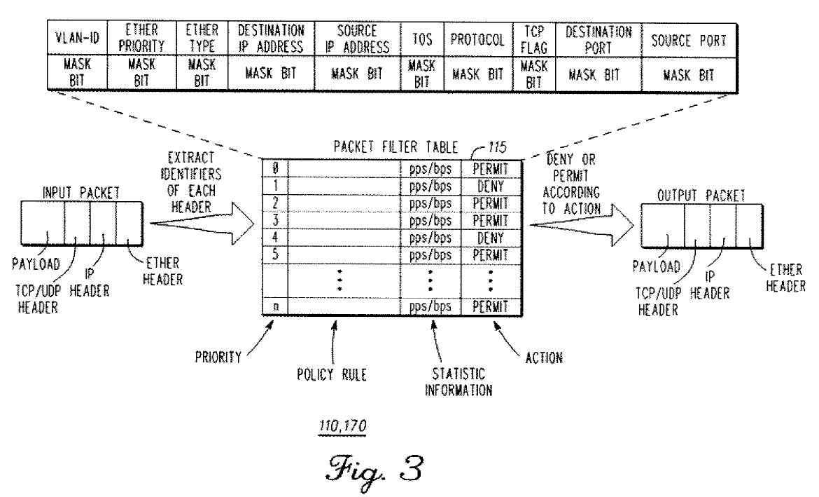

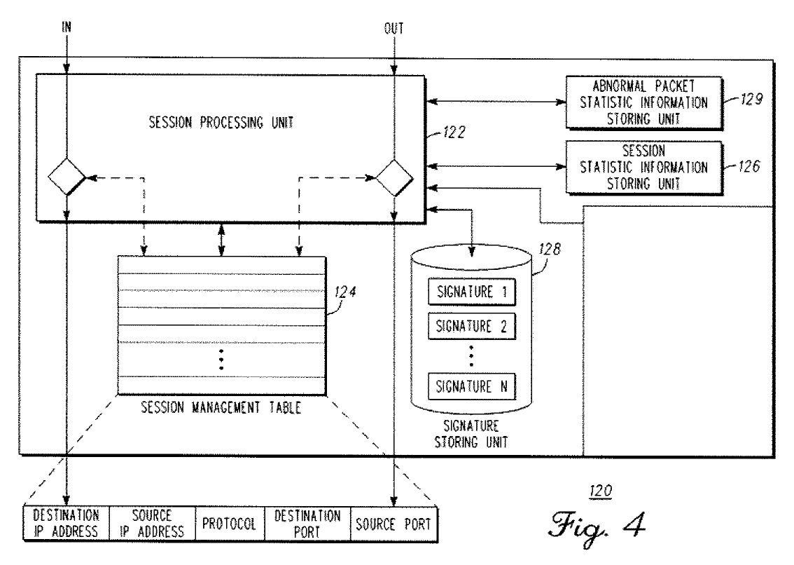

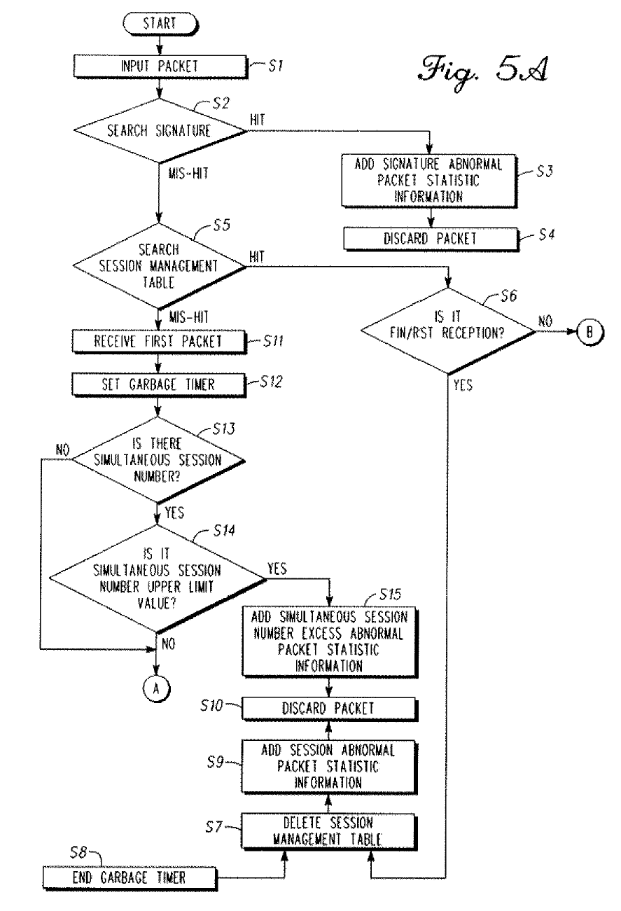

Hereinafter, a configuration of the Ingress and Egress packet filter units 110, 170 of the traffic collecting device 100, a configuration of the abnormal traffic detecting unit 120, and a flow of session processes will be described with reference to FIG. 3, FIG. 4 and FIG. 5. Based on such information and conditions, a real time statistic information setting/managing unit 704 shown in FIG. 8 is designed.

FIG. 3 shows a configuration the Ingress packet filter unit 110 and the Egress packet filter unit 170. The packet filter units 110, 170 include a packet filter table 115. As the identifiers of the ether header, the IP header, and the TCP/UDP header that can be set by a policy rule, a VLAN-ID, an ether priority, an ether type, a destination IP address, a source IP address, a TOS, a protocol number, a TCP flag, a destination port number, and a source port number are listed as shown in FIG. 3. In each identifier, a mask bit is designated so that a range-search can be performed.

In the packet filter table 115, a priority is assigned to each entry. In the example shown in FIG. 3, a small number has high priority. As a result of searching identifiers, an entry that is hit with higher priority is employed, and “permit” or “deny” is selected according to an action (permit or deny) corresponding to each entry that is preset. The packet filter table 115 has a packet counter (pps) and a byte counter (bps) as statistic information for each entry. The packet counter and the byte counter are incremented by all entries that were hit as a result of the research.

FIG. 4 is a schematic diagram illustrating the configuration of the abnormal traffic detecting unit 120. The abnormal traffic detecting unit 120 includes a session processing unit 122, a session management table 124, a session statistical information storing unit 126, a signature storing unit 128 and an abnormal packet statistic information storing unit 129. Both packets at the In side and the Out side entered into the abnormal traffic detecting unit 120 are entered into the session processing unit 122, and are processed in accordance with the flow diagram of session processing in FIG. 5.

Herein, the session processing will be described with reference to both FIGS. 4, 5A and 5B. First, at S1, a packet is entered into the session processing unit 122. Next, at S2, a signature is searched. Signatures registered in the signature storing unit 128 each describe a pattern that is an abnormal packet such as, for example, a pattern in which the destination IP address is the same as the source IP address, the source IP address is false, or an IP packet exceeds the maximum length when the IP packet is rebuilt with a destination host. When the signature is hit, the process proceeds to S3. At S3, the signature abnormal packet statistical information is added, and the packet is discarded at S4.

If the signature is mis-hit, meaning that the signature is not found during searching, at S2, the process proceeds to S5, and then a session management table is searched. When a packet is hit in the session management table, the process proceeds to S6, and then it is determined whether or not FIN/RST is received. When FIN/RST is received at S6, the process proceeds to S7, and in response to an end of garbage timer at S8, the session management table is deleted. Then, the session abnormal packet statistical information is added at S9, and the packet is discarded at S10.

In the meantime, if the session management table is mis-hit at S5, the process proceeds to S11, and then a first packet is received. Next, at S12, a garbage timer is set, and at S13, it is determined whether or not the number of simultaneous sessions is registered.

When the number of simultaneous sessions is registered at S13, the process proceeds to S14, and then it is determined whether or not the number of simultaneous sessions is an upper limit value. If the number of simultaneous sessions is the upper limit value at S14, the statistical information of the abnormal packets whose number of abnormal sessions exceeds the upper limit value at S15 is added, and the packets are discarded at S10. In the meantime, if the number of the simultaneous sessions is not an upper limit value at S14 or the number of the simultaneous sessions is not registered at S13, the process proceeds to S16.

At S16, it is determined whether or not the number of sessions per second is registered. If the number of sessions per second is registered, it is determined at S17 whether or not the number of sessions per second is an upper limit value.

When the number of sessions per second is an upper limit value at S17, the statistical information of a packet whose number of sessions per second exceeds the upper limit value is added at S18, and the packet is discarded at S19.

In the meantime, if the number of sessions per second is not an upper limit value at S17 or the number of sessions per second is not registered at S16, the process proceeds to S20.

At S20, the session statistical information is added. At S21, the session management table is registered. At S22, a packet is output. After S22, the process is finished (END).

The session processed by the session processing unit 122 is registered in the session management table 124. At this time, the identifiers to be registered are five identifiers (destination IP address, source IP address, protocol number, source port number and origin port number) shown in FIG. 4. The session statistical information storing unit 126 stores the session number registered in the session management table 124 by each combined unit of the destination IP) address and the source IP address.

The packet entered into the abnormal traffic detecting unit 120 at S2 in FIG. 5 is compared with each signature registered in the signature storing unit 128, and then it is determined whether or not the packet is an abnormal packet. As described above, the signature registered in the signature storing unit 128 is a description of a pattern, which is an abnormal packet such as, for example, when the destination IP address and the source IP address are the same or the source IP address is fabricated or an IP packet is re-structured by a destination host, a pattern exceeding the maximum length is described. The abnormal packet statistical information storing unit 129 stores the number of abnormal packets detected in signatures, and when the signature is hit at S2, the abnormal statistical information is added at S3.

The traffic analyzing device 700a periodically retrieves, processes and oversees data collected by the ingress packet filter statistic collecting unit 191, the abnormal traffic detection statistic collecting unit 192 and the egress packet filter statistic collecting unit 193 of the management unit 190 in the traffic collecting device 100, and then creates a real time table, a graphical display and a report. The traffic analyzing device 700a, for the purpose of implementing a report and analysis based upon the data collected by the traffic collecting device 100, recognizes the format information of collected data and a data collecting method.

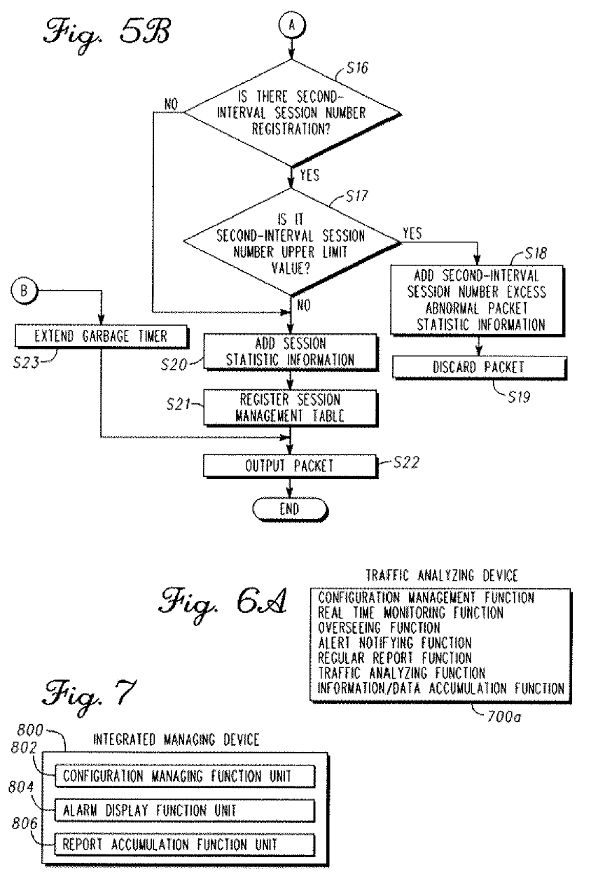

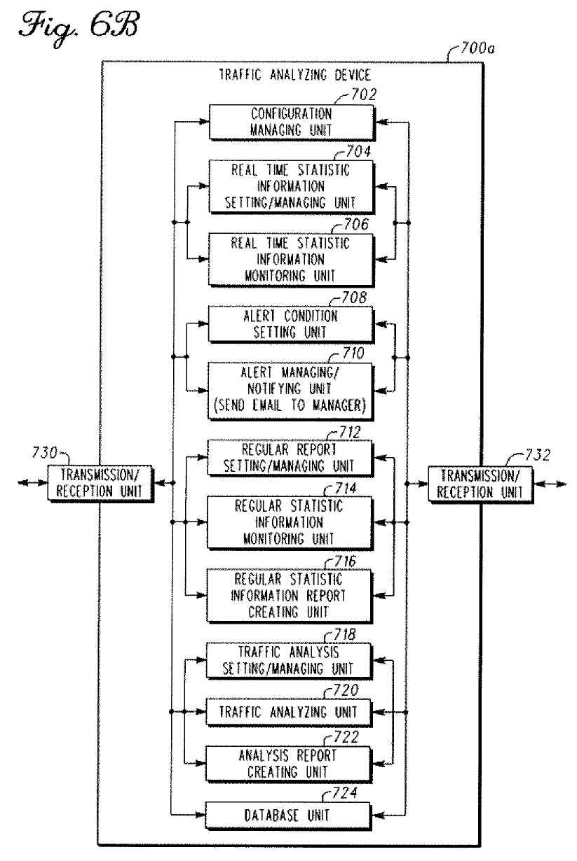

FIG. 6A is a schematic diagram illustrating functions of the traffic analyzing device 700a and FIG. 6B is a schematic diagram illustrating a configuration for realizing the functions. The traffic analyzing device 700a is equipped with a central processing unit (CPU), and each component of the traffic analyzing device 700a can be realized by operating the central processing unit by software (computer program).

As shown in FIG. 6A, the traffic analyzing device 700a has a configuration management function, a real time monitoring function, an overseeing, function, an alert notifying function, a regular report function, an automatic analyzing function (traffic analyzing function) and a data accumulation function.

Further, as shown in FIG. 6B, the traffic analyzing device 700a is composed of a configuration managing unit 702, a real time statistic information setting/managing unit 704, a real time statistic information monitoring unit 706 (as a real time monitoring unit), an alert condition setting unit 708, an alert managing/notifying unit 710, a regular report setting/managing unit 712, a regular statistic information monitoring unit 714, a regular statistic information report creating unit 716, a traffic analysis setting/managing unit 718, a traffic analyzing unit 720, an analysis report creating unit 722 and a database unit 724. Further, the traffic analyzing device 700a includes a transmitter-receiver, or transceiver, 730 that transmits and receives information into/from the traffic collecting device 100 and a transmitter-receiver, or transceiver, 732 that transmits and receives information into/from the integrated managing device 800.

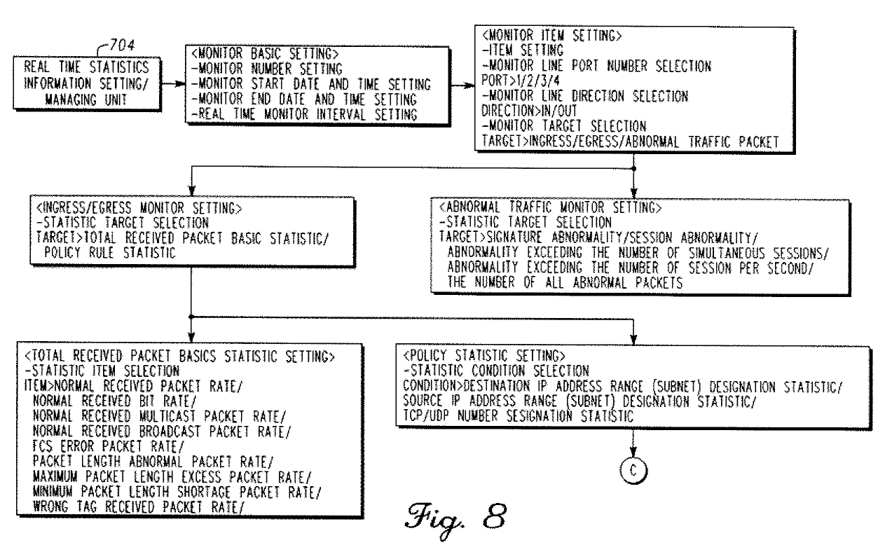

An alert issued by the traffic analyzing device 700a while overseeing the traffic and a regular report and an analysis report are sent to the integrated managing device 800 that integrally manages a plurality of traffic analysis devices 700a-700c shown in FIG. 1. FIG. 7 is a schematic diagram illustrating a functional configuration of the integrated managing device 800. The integrated managing device 800 is equipped with a configuration managing function unit 802, an alarm display function unit 804 and a report accumulation function unit 806. A manager can integrally manage the plurality of traffic analysis devices 700a-700c and refer to traffic data of each traffic analyzing device 700a-700c with the integral managing device 800.

The real time monitoring unit of the traffic analyzing device 700a is realized by the real time statistic information setting/managing unit 704 and the real time statistic information monitoring unit 706.

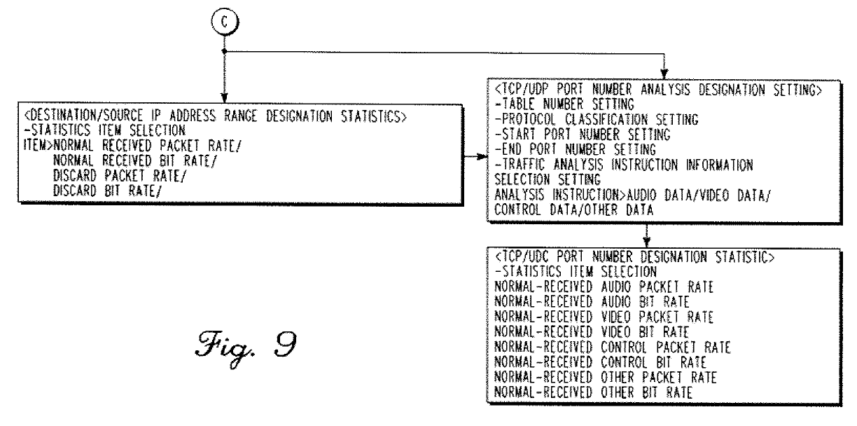

FIG. 8 and FIG. 9 are schematic diagrams illustrating the configuration of the real time statistic information setting/managing unit 704.

The real time statistic information setting/managing unit 704 manages the setting of information to be monitored on the occasion of collecting information in real time by the traffic analyzing device 700a. As shown in FIG. 8, the real time statistic information setting/managing unit 704 manages the monitor basic setting and the monitor item setting. As the monitor item setting, there are ingress/egress monitor setting and abnormal traffic monitor setting. As the ingress/egress monitor setting, there are total received packet basic statistic setting and policy rule statistic setting. Then, as the policy rule statistic setting, as shown in FIG. 9, there are two settings; one is set by the item selection of destination/source IP address range designation statistic and other is set by TCP/UDP port number analysis designation. In addition, as the TCP/UDP port number analysis designation, there is setting by the item selection of the TCP/UDP port number designation statistic.

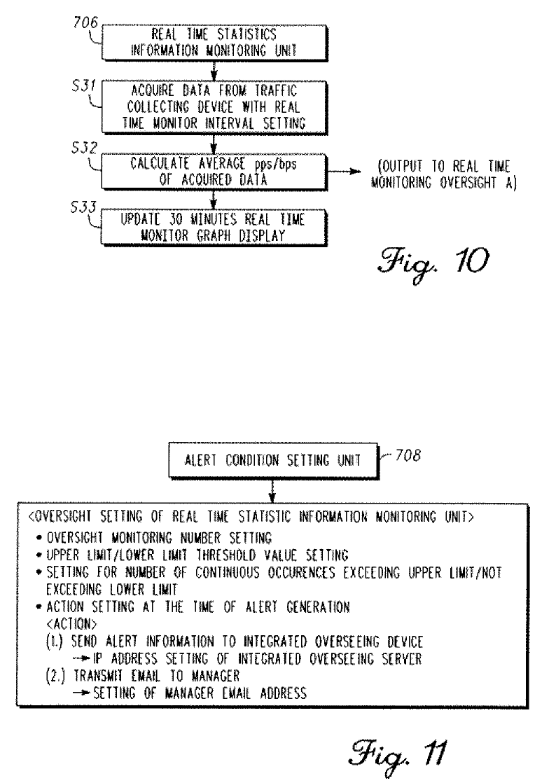

FIG. 10 is a schematic diagram illustrating the processing of the real time statistic information monitoring unit 706. The real time statistic information monitoring unit 706 acquires data from the traffic collecting device 100 at intervals set by the real time monitoring interval setting (S31). Then, an average value of packets per second/bits per second (pps/bps) of the acquired data is calculated (S32), and the display of the 30 minutes real time monitoring graphic is updated (S33). The average value pps/bps calculated at S32 is output to a real time monitoring oversight A.

The overseeing function and the alert notifying function of the traffic analyzing device 700a are performed by coordination of the real time statistic information monitoring unit 706, the alert condition setting unit 708 and the alert managing/notifying unit 710.

FIG. 11 is a schematic diagram illustrating the setting conducted by the alert condition setting unit 708. As shown in FIG. 11, the alert condition setting unit 708 mainly conducts the oversight setting of the real time statistic information monitoring unit 706, and sends alert information to the integrated management device 800 at the time of alert occurrence and conducts further actions, such as sending an email to a manager at, for example, manager terminal 900 in FIG. 1.

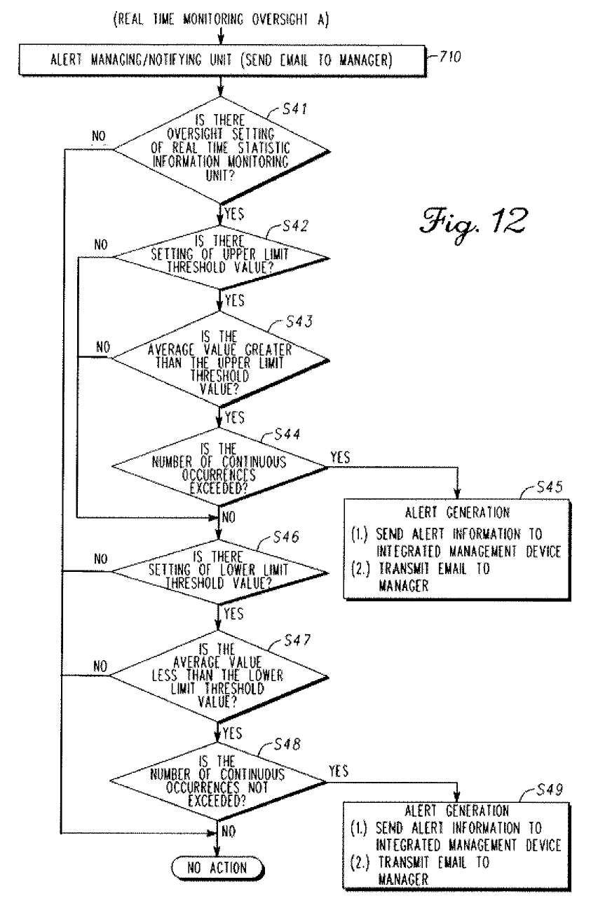

FIG. 12 is a flow diagram illustrating the processing of the alert managing/notifying unit 710 shown in FIG. 6B with the real time monitoring oversight A being one of the functions of the traffic analyzing device 700a in FIG. 6B. The alert managing/notifying unit 710 generates an alert based upon the average value pps/bps output to the real time monitoring oversight A. First, at S41, it is confirmed whether or not the oversight setting of the real time statistic information monitoring exists, and if it is confirmed, the process proceeds to S42. At S42, it is confirmed whether or not an upper limit threshold value is set is confirmed, and if the upper limit threshold value is set, it is determined at S42 whether or not the average value pps/bps has exceeded the upper limit threshold value.

If the average value pps/bps has exceeded the upper limit threshold value at S43, the process proceeds to S44, and it is determined in S44 whether or not the average value pps/bps exceeds the number of continuous occurrences. If the average value pps/bps has exceeded the number of continuous occurrences, the process proceeds to S45, and an alert is generated. Specifically, processing, such as alert information sent to the integrated management device 800 or an email transmission to a manager, is executed.

In the meantime, if there is no setting about the upper limit threshold value at S42, if the average value pps/bps has not exceeded the upper limit threshold value at S43, or if the average value pps/bps has not exceeded the number of continuous occurrences at S44, the process proceeds to S46. At S46, it is determined whether or not a lower limit threshold value is set, and if the lower limit threshold value is set, the process proceeds to S47.

At S47, it is determined whether or not the average value pps/bps is less than the lower limit threshold, or critical, value (whether or not the average value pps/bps is lower than the lower limit threshold value, and if the average value pps/bps is less than the lower limit threshold value, the process proceeds to S48, and then, it is determined whether or not the average value pps/bps has exceeded the number of continuous occurrences. If the average value pps/bps has exceeded the number of continuous occurrences, the process proceeds to S49, and an alert is generated. Specifically, processing, such as sending alert information to the integrated management device 800 or sending an email to a manager, is executed.

In the meantime, if there is no oversight setting at S41, or if a lower limit threshold is not set at S46, if the average value pps/bps has not exceeded the lower limit threshold value at S47, or if the average value pps/bps has not exceeded the number of continuous occurrences at S48, the action will not take place. As described above, the alert managing/notifying unit 710 can generate an alert by comparing the setting of the alert condition setting unit 708 with the average value pps/bps.

The regular report function of the traffic analyzing device 700a is realized by the regular report setting/managing unit 712, the regular statistic information monitoring unit 714 and the regular statistic information report creating unit 716.

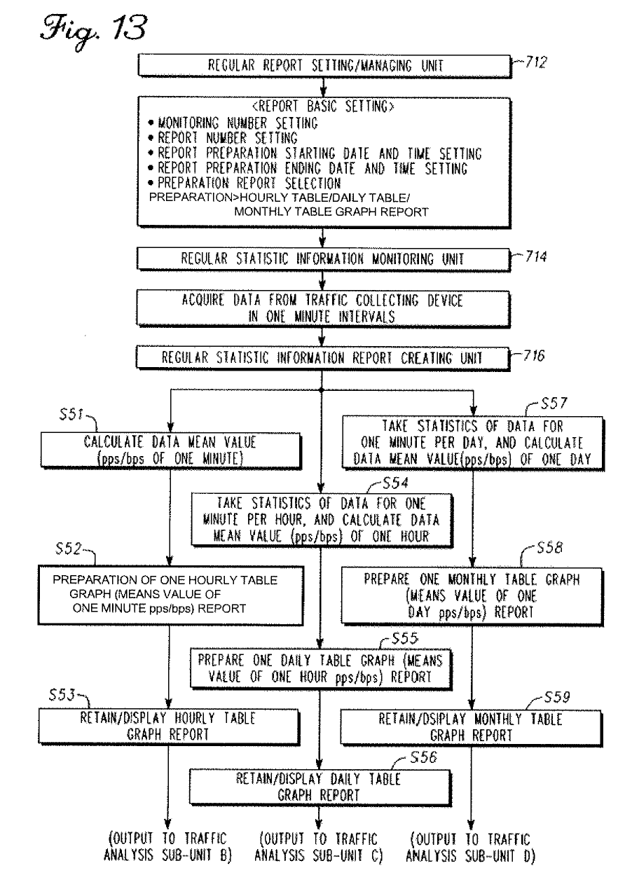

FIG. 13 is a schematic diagram illustrating processing by the regular report setting/managing unit 712, the regular statistic information monitoring unit 714 and the regular statistic information report creating unit 716. As shown in FIG. 13, the regular report setting/managing unit 712 conducts the basic setting of reports. The regular statistic information monitoring unit 714 acquires data from the traffic collecting device 100 at predetermined intervals (for example, at one minute intervals). The regular statistic information report creating unit 716 maintains/displays an hourly table graphical report, a daily table graphical report and a monthly table graphical report by processing at S51 to S53, S54 to S56 and S57 to S59 in FIG. 13, respectively. The hourly table graphical report is output to the traffic analysis sub-unit B, the daily table graphical report is output to the traffic analysis sub-unit C and the monthly table graphical report is output to the traffic analysis sub-unit D.

The traffic analysis function of the traffic analyzing device 700a is performed by analyzing the regular report and data using the traffic analysis setting/managing unit 718, the traffic analyzing unit 720 and the analysis report creating unit 722.

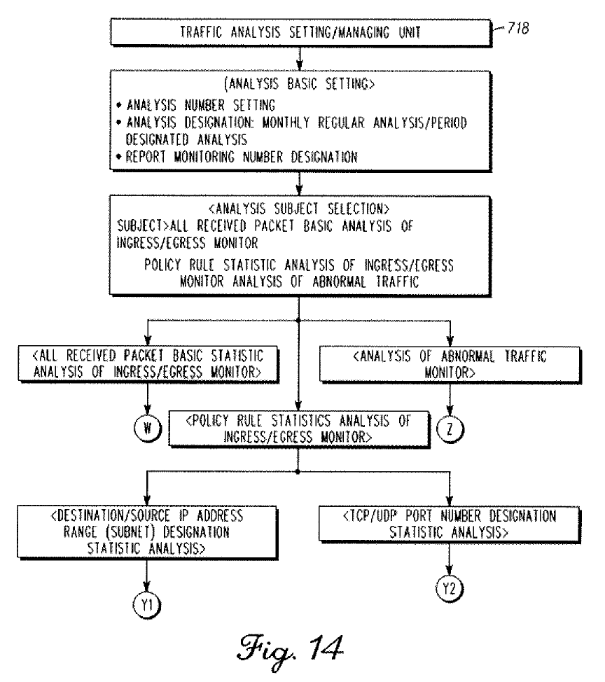

FIG. 14 is a schematic diagram illustrating the processing by the traffic analysis setting/managing unit 718. As shown in FIG. 14, the traffic analysis setting/managing unit 718 conducts a basic analysis setting, and, according to the selection of an analysis subject, one of the received packet basic statistic analysis of the ingress/egress monitor (W), policy rule statistic analysis of the ingress/egress monitor, or analysis of the abnormal traffic monitor (Z) is selected. As the policy rule statistic analysis of the ingress/egress monitor, processing of the destination/source IP address range (sub-net) designation statistic analysis (Y1) and the TCP/UDP port number designation statistic analysis (Y2) is conducted.

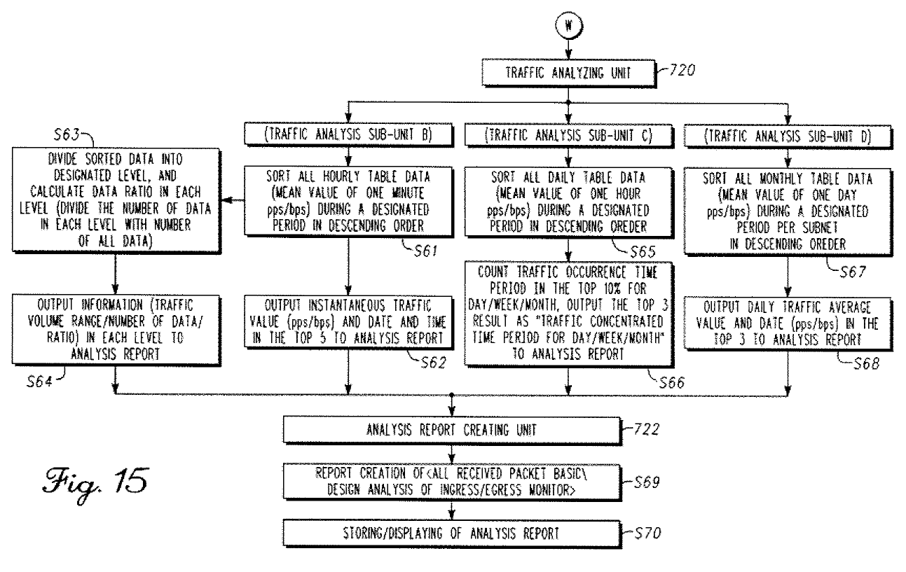

FIGS. 15-18 are schematic diagrams illustrating the processing by the traffic analyzing unit 720 and the analysis report preparing, or creating, unit 722. Herein, FIG. 15 shows the entire received packet basic statistic analysis (W) of the ingress/egress monitor. The traffic analyzing unit 720 analyzes the traffic based upon the hourly table graphical report, the daily table graphical report and the monthly table graphical report output from the regular statistic information report creating unit 716.

The hourly table graphical report is entered into the traffic analysis sub-unit B, and the traffic analysis sub-unit B sorts all of the hourly table data (mean value for one minute (pps/bps)) during a designated period in descending order (S61), and outputs the value of instantaneous traffic data (pps/bps) and date and time in the top 5 to the analysis report (S62). Further, the data sorted at S61 is divided into designated levels, and a data ratio (divide the number of data in each level with the number of data in all data) is calculated (S63). Then, information in each level (range of traffic value/the number of data/ratio) is output to the analysis report (S64).

The daily table graphical report is entered into the traffic analysis sub-unit C, and the data of the entire daily table (mean value of one hour (pps/bps)) during a designated period) is sorted in descending order (S65), and the occurrence time periods of traffic in the top 10% for day/week/month are counted, and the range of 10% of the traffic value and the time periods in the top 3 are output to the analysis report as the time period (as traffic concentrated time period) where the traffic value is concentrated for day/week/month (S66).

The monthly table graphical report is entered into the traffic analysis sub-unit D, and the monthly table data (mean value of one day (pps/bps)) during a designated period is sorted per sub-net in descending order (S67), and the daily traffic average value (pps/bps) in the top 3 and dates are output into the analysis report (S68).

The analysis report creating unit 722 prepares an analysis report based upon the traffic analysis by the traffic analyzing unit 720 (S69), and stores and display this report (S70).

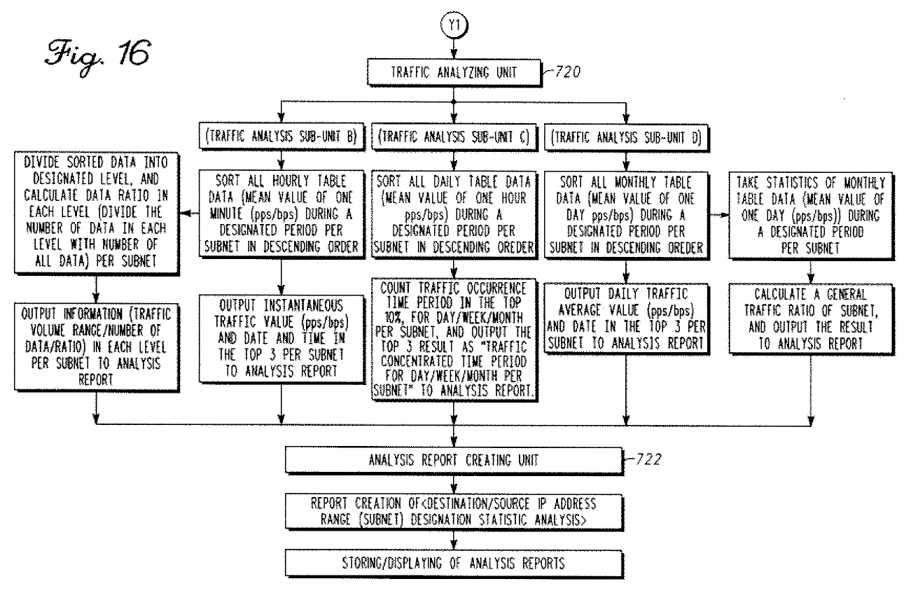

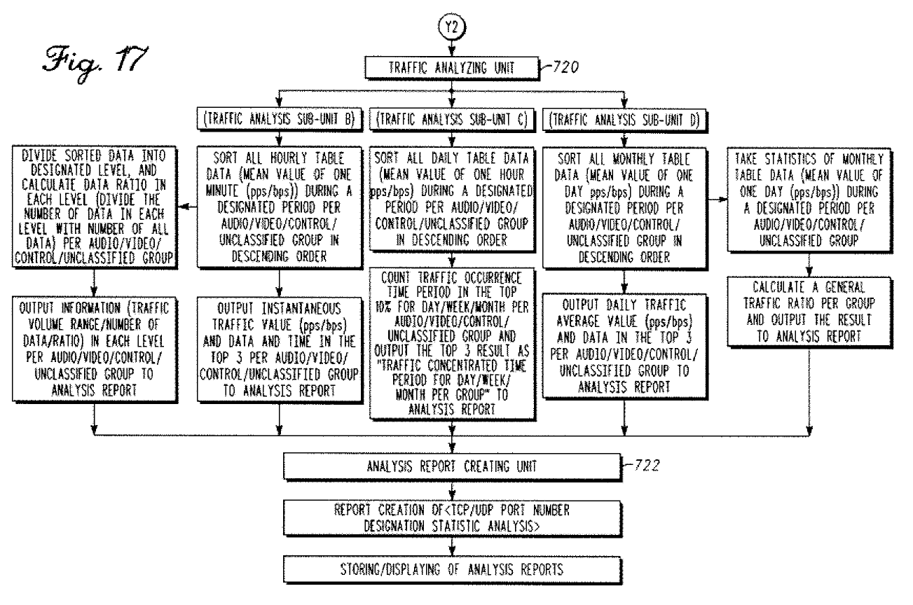

Further, FIG. 16 shows the destination/source IP address range (sub-net) designation statistic analysis (Y1). The basic processing in FIG. 16 is similar to that in FIG. 15; however, the processing is conducted per sub-net in FIG. 16.

Further, FIG. 17 is a schematic diagram illustrating the TCP/UDP port number designation statistic analysis (Y2). The basic processing in FIG. 17 is similar to that in FIG. 15; however, the processing is conducted per data, such as audio/video/control/unclassified group in FIG. 17.

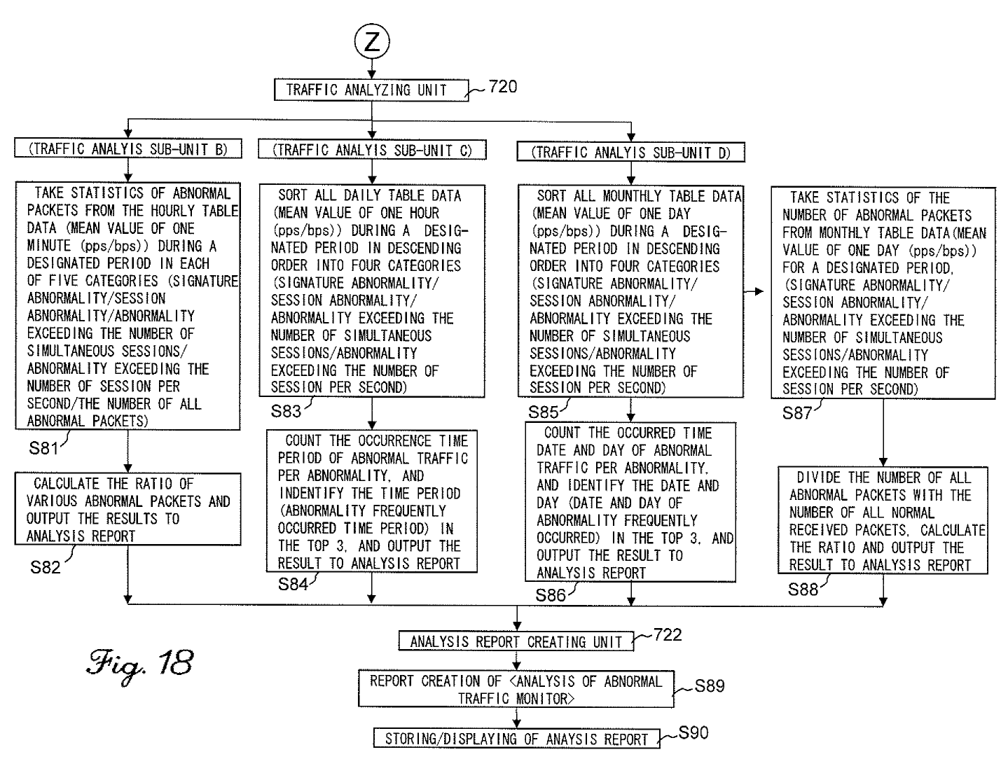

Further, FIG. 18 is a schematic diagram illustrating the analysis of abnormal traffic monitor (Z). As shown in FIG. 18, the hourly table graphical report is entered into the traffic analysis sub-unit B, and abnormal packets in the overall hourly time data are counted in each of five abnormal packet identification categories: 1) signature abnormality, 2) session abnormality, 3) abnormality by exceeding the number of simultaneous sessions, 4) abnormality by exceeding the number of sessions per second, 5) entire number of abnormal packets (mean value of one minute (pps/bps))−during a designated period (S81). Then, ratios of various abnormal packets are calculated, and the results are output to the analysis report (S82).

The daily table graphical report is entered into the traffic analysis sub-unit C, and the entire daily table data (mean value of one hour (pps/bps)) during a designated period is sorted in descending order into four categories: 1) signature abnormality, 2) session abnormality, 3) abnormality by exceeding the number of simultaneous sessions, 4) abnormality by exceeding the number of sessions per second (S83), and the occurrence time periods of the abnormal traffic are counted per abnormality, and the time periods in the top 3 (abnormality frequency occurrence time period) are identified and are output to the analysis report (S84).

The monthly table graphical report is entered into the traffic analysis sub-unit D, and the monthly table data (average value of one day (pps/bps)) during a designated period is sorted in descending order into four categories: 1) signature abnormality, 2) session abnormality, 3) abnormality by exceeding the number of simultaneous sessions, 4) abnormality by exceeding the number of sessions per second (S85), and the occurrence time and date and day of the abnormal traffic is counted, and date and day (date and day when abnormalities frequently occurred) in the top 3 are identified and output to the analysis report (S86). Further, according to the monthly table data (mean value of a day (pps/bps)) during a designated period, the total number (statistics) of abnormal packets is counted (S87), and a ratio of the number of total abnormal packets/the number of total normal received packets is calculated, and output to the analysis report (S88).

The analysis report creating unit 722 prepares an analysis report based upon the traffic analysis (analysis of abnormal traffic monitor) by the traffic analyzing unit 720 (S89), and maintains and displays the report (S90).

As described above, according to this embodiment, abnormal traffic/normal traffic is monitored and overseen in real time, and an alert email identifying when traffic exceeds a threshold value can be transmitted to a manager. Further, since regular reports (graphical) of hourly table/daily table/monthly table can be produced, an actual condition of traffic can be easily analyzed.

Further, according to the all received basic statistic analysis of ingress/egress monitor, it becomes possible to analyze the instantaneous traffic value in the top 5 congestion and the occurrence date & time, a ratio of traffic in each level, traffic value range in the top 10% of the traffic congestion, time periods in the top 3 congestion, traffic value (pps/bps) of day-averaged data in the top 3 congestion and date of them.

Further, according to the statistic analysis of the destination/source IP address range (sub-net) designation, it becomes possible to analyze the instantaneous traffic value in the top 3 congestion and the occurrence date and time thereof, ratios of traffic in each level, the range of the traffic value in the top 10% of the traffic congestion and time periods in the top 3 congestion, the traffic value (pps/bps) of daily-averaged data in the top 3 congestion and corresponding occurrence dates, and the traffic ratio of each general sub-net, per sub-net.

Further, according to the TCP/UDP port number designation statistic analysis, ratios of traffic in each level categorized by audio/video/control/unclassified group, the instantaneous traffic data value (pps/bps) in the top 3 congestion and date and time, the traffic value range in the top 10% of the traffic congestion and the concentrated time periods in the top 3 congestion, the day-averaged data traffic value (pps/bps) in the top 3 congestion and corresponding occurrence dates, and each of general traffic ratios can be analyzed.

Further, according to the analysis of the abnormal traffic monitoring, a ratio of various abnormal packets, time periods of abnormal traffic occurrence in the top 3 congestion, occurrence date (day) in the top 3 congestion, and a ratio of the number of entire abnormal packets and the number of entire normal received packets can be analyzed.

Therefore, according to this embodiment, it is unnecessary for a network manager to analyze traffic by himself/herself or to request a vender traffic analysis, and he/she can easily understand the condition of each network line. With this design, it becomes possible to reduce a burden upon the network manager and to reduce network operation costs.

The preferred embodiment of the present invention has been described with reference to the attached drawings; however, it is needless to say, the present invention shall not be limited to the related example. In the scope described in the scope of claims, it is obvious that a person with ordinary skills in the art pertaining to the present invention could have invented various modified examples and corrected examples, and it is understood that these are within the technical scope of the present invention.

What is claimed is:

1. A network traffic analyzing device for analyzing traffic, comprising:
a real time monitoring unit configured to collect information regarding communication data between a primary network and an access network from a traffic collecting device in real time;
an alert condition setting unit configured to set one or more alert conditions regarding the information collected from the traffic collecting device in real time; and
an alert managing/notifying unit configured to generate an alert regarding traffic between the primary network and the access network based upon the one or more alert conditions.

2. The network traffic analyzing device according to claim 1, wherein regarding the information collected from the traffic collecting device in real time, the traffic is analyzed based upon at least one of a graphical representation of the information per hour, a graphical representation of the information per day and a graphical representation of the information per month to produce analysis results.

3. The network traffic analyzing device according to claim 2, further comprising an analysis report creating unit configured to create a report based upon the analysis results.

4. The network traffic analyzing device according to claim 2, wherein
the information collected from the traffic collecting device in real time includes information collected by a packet filter of the traffic collecting device or information collected regarding abnormal traffic; and
the network traffic analyzing device conducts a basic statistical analysis of all received packets based upon at least one of the information collected by the packet filter, a statistic analysis of packets within a specific range based upon the information collected by the packet filter, and an abnormal traffic analysis based on the information collected regarding abnormal traffic.

5. The network traffic analyzing device according to claim 1, further comprising:
a traffic analysis setting/managing unit configured to conduct a setting for an analysis of the traffic information collected from the traffic collecting device; and
a traffic analyzing unit configured to analyze the traffic information collected from the traffic collecting device, based on results of the analysis set by the traffic analysis setting/managing unit, and to generate an analysis output.

6. The network traffic analyzing device according to claim 5, further comprising a report creating unit configured to create reports based on the analysis output generated by the traffic analyzing unit.

7. The network traffic analyzing device according to claim 1, wherein the alert managing/notifying unit is configured to generate the alert by comparing an alert setting of the alert condition setting unit with an average rate per unit time of acquired traffic data.

8. The network traffic analyzing device according to claim 2, wherein the graphical representation of the information per hour, the graphical representation of the information per day and the graphical representation of the information per month comprises abnormality occurrence time period information.

9. The network traffic analyzing device according to claim 1, further comprising:
a real time statistic information setting/managing unit configured to manage a setting of information to be monitored; and
a real time statistic information monitoring unit configured to acquire data from the traffic collecting device at intervals set by a real time monitoring interval setting, calculate an average value of packets per second/bits per second (pps/bps) of the acquired data, and update a display of a real time monitoring graphical representation for a predetermined period so that the average value pps/bps calculated is output to a real time monitoring oversight.

10. The network traffic analyzing device according to claim 1, wherein the alert managing/notifying unit is configured to generate the alert when an average value of the traffic per unit time exceeds an upper limit threshold value, and exceeds a number of continuous occurrences.

11. The network traffic analyzing device according to claim 1, wherein the alert managing/notifying unit generates the alert when an average value of the traffic per unit value does not exceed a lower limit threshold value, and does not exceed a number of continuous occurrences.

12. The network traffic analyzing device according to claim 1, further comprising a regular report setting/managing unit, a real time statistic information monitoring unit, and a regular statistic information report creating unit, wherein
the regular report setting/managing unit conducts a basic setting of reports,
the real time statistic information monitoring unit acquires data from the traffic collecting device at predetermined intervals, and
the regular statistic information report creating unit maintains/displays either an hourly, daily, or monthly table graphical report.

13. The network traffic analyzing device according to claim 2, wherein when the graphical representation of the information per hour is entered into the traffic analyzing device, the traffic analyzing device sorts hourly during a designated period and outputs a value of instantaneous traffic data as well as time and date data as the analysis results.

14. The network traffic analyzing device according to claim 2, wherein when the graphical representation of the information per day is entered into the traffic analyzing device, the traffic analyzing device sorts daily in descending order, and occurrence time periods of the traffic in a predetermined ranges, and the occurrence time periods of the traffic are output as the analysis results as time periods where the traffic is concentrated.

15. The network traffic analyzing device according to claim 2, wherein when the graphical representation of the information per month is entered into the traffic analyzing device, the traffic analyzing device sorts monthly data in descending order and sub-net, daily-averaged traffic value and dates are output as the analysis results.

16. A network traffic analyzing method, comprising:
collecting information regarding communication data between a primary network and an access network from a traffic collecting device in real time;
setting one or more alert conditions regarding the information collected from the traffic collecting device in real time; and
generating an alert regarding traffic between the primary network and the access network based upon the one or more alert conditions.

17. The network traffic analyzing method according to claim 16, wherein the setting of alert conditions comprises setting at least one of an upper threshold limit and a lower threshold limit for abnormal packets received per unit time.

18. A network traffic analyzing system connecting a traffic collecting device for collecting traffic information from a primary network and an access network with a network traffic analyzing device for analyzing the traffic information, wherein
the network traffic analyzing device comprises:
a real time monitoring unit configured to collect information regarding communication data between the primary network and the access network from the traffic collecting device in real time;
an alert condition setting unit configured to set alert conditions regarding the information collected from the traffic collecting device in real time; and
an alert managing/notifying unit configured to generate an alert regarding traffic between the primary network and the access network based upon the alert conditions.

19. The network traffic analyzing system according to claim 18, wherein the traffic collecting device includes an abnormal traffic detecting unit for detecting signatures that describe patterns indicating abnormal traffic and a reception/transmission unit for interfacing the traffic collecting device with a management unit.

20. The network traffic analyzing system according to claim 19, wherein the abnormal traffic detecting unit is configured to perform a signature search to detect whether a number of simultaneous sessions is greater than an upper limit value, and whether a number of sessions per unit time is registered.
